(19) United States
(12) Patent Application Publication
(10) Pub. No.: US 2011/0028062 A1
(43) Pub. Date: Feb. 3, 2011

(54) BICOMPONENT FIBERS, TEXTILE SHEETS AND USE THEREOF

(76) Inventors: Stephen O. Chester, Simpsonville, SC (US); Steffen Bornemann, Jessnitz (DE)

Correspondence Address: FERRELLS, PLLC, P. O. BOX 312, CLIFTON, VA, 20124-1706, US

(21) Appl. No.: 12/735,735

(22) PCT Filed: Feb. 14, 2008
(86) PCT No.: PCT/EP2008/001109

§ 371 Date: Sep. 29, 2010

(51) Int. Cl. D04H 3/16; D02G 3/04; D04H 13/00; A01C 1/04

(52) U.S. Cl. 442/401; 428/373; 442/415; 47/56

(57) ABSTRACT

Disclosed are bicomponent fibers with aliphatic polyester forming a first component and a polyolefin forming a second component wherein the polyolefin contains an adjuvant improving the biodegradability of said polyolefin. Textile sheets comprising these bicomponent fibers are comparable in their mechanical properties to polyolefin based textile sheets while these are more efficiently decomposed by the action of microorganisms as polyolefin based textile sheets.

### CLAIM FOR PRIORITY

This application is a national phase entry of International Application No. PCT/EP2008/001109, filed Feb. 14, 2008, entitled “Bicomponent Fibers, Textile Sheets and Use Thereof”. The priority of International Application No. PCT/EP2008/001109 is hereby claimed and its disclosure incorporated herein by reference in its entirety.

### FIELD OF THE INVENTION

This application relates to bicomponent fibers of core-sheath type with improved biodegradability. Textile sheets comprising these fibers can be used in different fields of applications, such a textile applications or as industrial applications. Preferably, textile sheets are prepared as nonwovens, which can be used in personal care articles.

### BACKGROUND OF THE INVENTION

Biodegradable fibers and textile sheets made therefrom are known. One approach for improving biodegradability is the use of polymers which are known to show an improved biodegradation behavior as compared with, for example, polyolefins. Another approach for improving biodegradation of polymers is the addition of agents which improve the speed of biodegradation of the polymer after use.

JP-A-2007-197,857 and U.S. Pat. No. 6,197,237 disclose spunbonds comprising fibers of a mixture of polyolefin and polylactic acid or of a mixture of polyolefin, aliphatic polyester polymer and a compatibilizer for both polymers. The polyolefin is present in the form of microphases in a matrix of aliphatic polyester polymer.

US 2006/0159918 A1 discloses biodegradable fibers exhibiting storage-stable tenacity. These fibers are drawn and/or crimped and comprise a biodegradable polymer, for example an aliphatic polyester, such as polylactic acid, and exhibit a initial tenacity of at least 1.5 g/denier which remains virtually unchanged during storage for 120 days in ambient conditions.

JP 2006-030,905 A discloses a sound absorbing material which consists of a fiber structure body made of polylactic acid short fiber which is a bicomponent fiber made of polylactic acid of high molecular weight and of polylactic acid of low molecular weight. Furthermore the polylactic short fiber can be made in the form of a core-sheath-type with a polylactic core and an aromatic polyester sheath.

JP 2000-054,227 A discloses a polyolefin-based conjugate fiber consisting of a first component which is a polyolefin-based polymer, such as polyethylene, and of second component which is a polylactic acid-based polymer or a blend of selected polymers wherein said second component is disposed to partially expose on a part of the fiber surface. Different configurations of conjugate fibers are disclosed, for example a core-sheath-type having a polyolefin-core and a sheath of said second component.

The improvement of biodegradability of polyolefins by adding an adjuvant which accelerates the decomposition speed after use is disclosed, for example in the following documents: JP2004-182,877 A; JP 2005-255,744 A; JP 05-345,836 A; KR 1002-88,054 B; KR 10-1995-0113,175 B; KR 10-2001-0113,577 B; KR 10-2003-0071,175 B; U.S. Pat. No. 3,903,029 A and WO 2001-39,807 A.

Adjuvants for improvement of the decomposition speed of polyolefins after use are commercially available. Examples thereof are the products Envirocare (Ciba), Addiflex (Add-X Biotech AB) and ECM 6.0204 (ECM Biofilms).

While known products already can satisfy requirements of biodegradability these products often are not optimal in other aspects. Nonwovens made from polylactic acid, for example, often have a high shrinkage or a narrow thermobonding window. Nonwovens made of polyolefins can avoid these shortcomings but they are derived from oil and gas and not from renewable primary products.

Due to the increasing scarcity and cost of fossil resources, products made of alternative plastics are more and more becoming important now. Such alternative plastics include polymers made of renewable resources, or even polymers which are biodegradable or compostable. Usually, those plastics are classified as “biodegradable plastics”. Typical examples of such plastics are starch, cellulose or polylactic acid (PLA). PLA combines the advantage of renewable resources and biodegradability offering a desirable ecobalance. The disposal of the waste products made of such biodegradable plastics can be done by composting. Due to the biodegradation process, such materials will completely decompose to carbon dioxide, water and biomass. Thus, the waste can be managed by composting or landfill, no thermal treatment is needed. In the meltspinning process PLA is known as a plastic with good processability. Filaments with a broad range of fineness can be spun. However, some weaknesses can be seen: The bonding temperature window of the PLA fibers is narrow. Thus, in general the strength of the nonwovens is lower than known for conventional nonwovens made of polyester or polypropylene. Additionally, a high shrinkage of the PLA nonwovens has to be considered. The disadvantages of the PLA nonwovens can be overcome for example when the PLA in the fiber is covered. As an example, bicomponent filaments can be made containing a biodegradable plastic (like PLA) in the core and a conventional plastic (like a polyolefin) in the sheath. Such bicofilaments are offering a broader bonding temperature window. Also shrinkage of the nonwovens can be reduced that way successfully. Unfortunately, the advantages of the nonwovens made of bicofilament with biodegradable plastic in the core and polyolefin in the sheath are combined with a loss of the biodegradability or compostability. The polyolefins in the sheath are non-degradable plastics, protecting the biodegradable plastic in the core of the filaments. Consequently, a degradation process is inhibited or at least impeded.

### SUMMARY OF THE INVENTION

It is one object of this invention to provide fibers and textile sheets containing these fibers which comprise a high proportion of renewable primary products and show desirable properties, for example the thermobonding temperature window and/or shrink of polyolefin fibers as well as the thermobonding temperature window and/or shrink of textile sheets made from polyolefin fibers.

It is another object of this invention to provide fibers and textile sheets containing these fibers which are readily biodegradable.

It is still another object of this invention to provide fibers which can be produced on conventional spinning equipment using process parameters already in use in the manufacture of polyolefin fibers.

Further objects of this invention will become apparent from the following description.

In one embodiment this invention relates to a bicomponent fiber comprising aliphatic polyester or a mixture of aliphatic polyesters as a first component, and comprising a polyolefin or a mixture of polyolefins as a second component and comprising in the second component an effective amount of an adjuvant which improves the biodegradability of said polyolefin.

In another embodiment this invention relates to a textile sheet comprising the above defined bicomponent fiber.

Unexpectedly it has been found that by combining selected melt-spinnable polymers as a first component, for example in the core of a sheath-core bicomponent fiber, and polyolefins with selected adjuvants as a second component, for example in the sheath of a sheath-core bicomponent fiber, readily biodegradable fibers are formed which show similar properties as polyolefin fibers.

### DETAILED DESCRIPTION OF THE INVENTION

This invention is described in detail below with reference to several embodiments and examples. Such discussion is for purposes of illustration only.

The polymer component of the core of the bicomponent fibers of this invention is an aliphatic polyester or a mixture thereof. Besides this, the first component can contain additives, such as fillers, pigments, matting agents, processing agents, antistatic agents or adjuvants for improving the biodegradability.

The aliphatic polyester of the first component is a biodegradable synthetic melt-spinnable polymer.

The term “biodegradable” is used throughout this specification to define a product which degrades or decomposes under environmental conditions. Thus a product is considered as biodegradable in terms of this specification if the reduction of tensile strength and/or of peak elongation of said product is at least 50%, preferably at least 70%, of their initial value if subjected for six days to an oven accelerated ageing test using a drier cabinet at 80° C. Such test procedure for a biodegradation process is described in US 2007/0243350 A1

The polymer of the first component is derived from an aliphatic component possessing one carboxylic acid group (or a polyester forming derivative thereof, such as an ester group) and one hydroxyl group (or a polyester forming derivative thereof, such as an ether group) or is derived from a combination of an aliphatic component possessing two carboxylic acid groups (or a polyester forming derivative thereof, such as an ester group) with an aliphatic component possessing two hydroxyl groups (or a polyester forming derivative thereof, such as an ether group).

The term “aliphatic polyester” covers—besides polyesters which are made from aliphatic and/or cycloaliphatic components exclusively also polyesters which contain besides aliphatic and/or cycloaliphatic units aromatic units, as long as the biodegradability of these polyesters is not adversely affected by this.

Polymers derived from an aliphatic component possessing one carboxylic acid group and one hydroxyl group are alternatively called polyhydroxyalkanoates (PHA). Examples thereof are polyhydroxybutyrate (PHB), poly-(hydroxybutyrate-co-hydroxyvaleterate) (PHBV), poly-(hydroxybutyrate-co-polyhydroxyhexanoate) (PHBH), polyglycolic acid (PGA), poly-(epsilon-caprolactione) (PCL) and preferably polylactic acid (PLA).

Examples of polymers derived from a combination of an aliphatic component possessing two carboxylic acid groups with an aliphatic component possessing two hydroxyl groups are polyesters derived from aliphatic diols and from aliphatic dicarboxylic acids, such as polybutylene succinate (PBSU), polyethylene succinate (PESU), polybutylene adipate (PBA), polyethylene adipate (PEA), polytetramethy-lene adipate/terephthalate (PTMAT).

The polymer component of the second component of the bicomponent fibers of this invention is a polyolefin or a mixture thereof. Besides this said second component must contain at least an effective amount of an adjuvant which improves the biodegradability of the polyolefin. In addition, the second component can contain other additives, such as fillers, pigments, matting agents, processing agents and/or antistatic agents.

The polyolefins used as a second component material in general are derived from alpha-olefins. Typical examples for polyolefins are polyethylenes (PE) in either form, such as HDPE, LDPE, LLDPE, VLDPE and ULDPE, or polypropylene (PP) in either form, poly-(1-butene), poly-(1-pentene) or poly-(4-methylpent-1-ene). Besides homo-polymers also copolymers are included.

Examples thereof are copolymers of ethylene with one or more copolymerisable alpha-olefins, copolymers of propylene with one or more copolymerisable alpha-olefins, preferably copolymers of ethylene and/or propylene with higher 1-olefins, such as 1-butene, 1-pentene, 1-hexene, 1-heptene, 1-octene, 4-methyl-pent-1-ene- or 1-decene.

Further representatives of polyolefins are blends of polyolefins and/or polyolefins which contain portions derived from grafting of ethylenically unsaturated monomers on the polyolefin backbone.

The polyolefin of the second component contains an adjuvant promoting the biodegradability of said polyolefin. These adjuvants are known to those skilled in the art as outlined in the “background of invention” section hereof.

Preferably the products Envirocare (Ciba), Addiflex (Add-X Biotech AB) and ECM 6.0204 (ECM Biofilms) can be used.

The adjuvant promoting the biodegradability of the polyolefin preferably contains a nutrition component for microorganisms, preferably starch, an inorganic particulate compound, such as calcium carbonate and a transition metal salt, such as a carboxylate of iron, manganese, cobalt or copper. Examples of such adjuvants are found in US 2007/0243350A1.

The amount of the adjuvant promoting the biodegradability of the polyolefin can vary within wide ranges. For commercial considerations usually amounts as low as possible are used to make sure that the desired degree of biodegradability of the polyolefin is obtained. If higher amounts of this adjuvant are used the upper limit is given by the spinning process used in the bicomponent fiber formation. Thus any amount of this adjuvant can be used as long as this does not inhibit the fiber formation process.

A preferred adjuvant used in the manufacturing process of the bicomponent fibers of this invention is used as a masterbatch with a polyolefin as a carrier polymer.

Typical amounts of a masterbatch used in the manufacturing process of the fibers of this invention are within a range of 0.5-10% by weight, preferably 1-6% by weight, very preferably 3-5% by weight, referring to the total amount of the sheath forming components.

Typical concentrations of the adjuvant promoting the biodegradability of the polyolefin within said masterbatches are within a range of 0.075-1.5% by weight, referring to the total amount of the masterbatch.

A preferred masterbatch used in the manufacturing process of the fibers of this invention contains 25-85% by weight of polyolefin and adjuvant promoting the biodegradability which comprises 1-30% by weight of starch, 2-50% by weight of calcium carbonate and 0.5-15% by weight of a metal salt. The percentages refer to the total composition of the masterbatch.

The total amount of the adjuvant promoting the biodegradability of the polyolefin in the second component is typically within a range of 0.005-0.5% by weight, preferably 0.01-0.3% by weight, very preferably 0.03-0.25% by weight, referring to the total amount of the second component forming components.

Preferred bicomponent fibers of this invention possess a first component of a PLA polymer, very preferred as a core of a core-sheath fiber.

Further preferred bicomponent fibers of this invention possess a second component of a polyethylene and/or a polypropylene, very preferred as a sheath of a core-sheath fiber.

In another preferred embodiment of this invention the adjuvant improving the biodegradability of the polyolefin comprises a starch and a salt of a transition metal compound.

In an additional preferred embodiment of this invention the first component of the bicomponent fiber comprises a filler, preferably a carbonate of an earth alkaline metal, especially preferred calcium carbonate.

The bicomponent fibers of this invention can be endless fibers (filaments) or fibers of finite length (staple fibers). The bicomponent fibers of this invention typically possess a denier between 1 and 10 dtex. But this is not critical and smaller or higher deniers can be provided. Preferred fiber diameters are above 10 μm, especially between 10 and 20 μm.

The bicomponent fibers of this invention can contain the different polymer portions in any shape. Examples are core-sheath, side-by-side or island-in-the-sea configurations. Core-sheath configurations are preferred.

The bicomponent fibers of this invention can have a cross-section of any convenient shape. Examples of cross sections are found in Hearle J., “Fibers, 2.Structure” (Ullmann's Encyclopedia of Industrial Chemistry, Wiley-VCH: 2002, 1-85). Examples of preferred cross-sections are circular, elliptical, triangular or polygonal or tri- or multilobal.

The amount of first component and of second component may vary within wide limits. Typical ranges of first component are between 10 and 90% by weight. Typical ranges of second component are between 90 and 10% by weight. These percentages refer to the total amount of the fiber. Preferably the amount of the first component is higher than the amount of the second component, for example 55-90% by weight of first component, such as core, and 45-10% by weight of second component, such as sheath.

The bicomponent fibers of this invention can be transformed into textile sheets or into other forms of fiber strands, such as secondary spun yarns or cords.

The textile sheet comprising the fibers of this invention can be of either nature. Examples thereof are fabrics, knittings, knit fabrics, woven fabrics, scrims or preferably nonwovens.

The textile sheets of this invention can be formed in a manner known by the skilled artisan. Nonwovens, for example, can be formed by wet-laid methods or by dry-laid methods. Examples of these methods are carding processes for the production of carded webs and spunbond processes for the formation of spunbonded webs (spunbonds). These latter nonwovens are preferred.

The manufacture of the textile sheets of this invention typically comprises the following steps:
a) subjecting the bicomponent fibers of this invention and optionally together with other strands, such as staple fibers or filaments, to a textile sheet forming technology, to result in a primary textile sheet and
b) optionally subjecting said primary textile sheet to a stabilization treatment known in the art.

Depending on the type of textile sheet forming technology, such as weaving or knitting, the primary textile sheet obtained is sufficiently stabilized. In these cases step b) is not mandatory but can be performed. Thus in these cases the primary textile sheets can represent the final textile sheets.

In other types of textile sheet forming technology, such as forming nonwovens, the primary textile sheet obtained in general is not sufficiently stabilized. In most of these cases step b) is mandatory. Thus in these cases the primary textile sheets need to be further processed to result in the final textile sheets.

Besides nonwovens comprising or consisting of fibers of this invention layers of nonwovens made from other materials can be present. These multilayer nonwovens also constitute an object of the present invention.

Furthermore, the textile sheets besides the fibers of the invention can contain additional strands made of other materials, such as other polymers. These additional strands made of other materials can be present in either form, such as staple fibers, filaments or yarns. Examples of polymers forming such additional strands are cellulose, starch, proteins and/or of synthetic polymers, such as polyesters, polyamides or polyacrylonitrile.

The primary textile sheets described above can be or need to be stabilized after the sheet formation process in a manner known per se. This stabilisation treatment can be a mechanical treatment by the action of needles and/or by hydroentanglement or can be a stabilization by gluing the fibers forming the primary textile sheet, for example by adding an adhesive to the primary textile sheet and/or by thermal treating the primary textile sheet to cause the fibers and/or any binder fibers which may be additionally included in said primary textile sheet to stick together.

Other known treatment methods of the textile sheets may be performed during or after manufacture thereof. For example, the textile sheets may be subjected to a printing treatment, or the textile sheets, preferably the nonwovens, may embossed at least on one of their surfaces, for example by the action of a profiled calendering roll, to result in a surface pattern and in an additional solidification of selected parts of the textile sheet caused by melt adhesion of single fibers at the treated locations of the textile sheet.

One advantage of the bicomponent fibers of this invention is that they can be processed by sheet-forming technologies known from the manufacture of polyolefin textile sheets without changing the process parameters in relation to the known sheet manufacturing processes.

The textile sheets of this invention typically have an area weight of 10-200 g/m², preferably of 15-50 g/m².

The textile sheets of this invention can be used for personal care applications, for example products for babycare (diapers, wipes), for femcare (pads, sanitary towels, tampons), for adult care (incontinence products) or for cosmetic applications (pads).

The invention also relates to the use of the above-defined textile sheets in medical applications, for example as protective clothing or as operation covering, or in cleaning products. Furthermore, the above-defined textile sheets can be used in products for filtration applications, for acoustic protection, in automotive applications, as geotextiles, as canvas cover in agriculture, as a pot for plant breeding, as a nonwoven for sheets comprising seed and/or nutrients, as a bag, for example as shopping bag or as a frost protection coverage.

The following examples will explain the invention without limiting it.

### COMPARATIVE EXAMPLE 1

A nonwoven was produced by melt spinning bicomponent fibers with core-sheath configuration and by forming a spunbond with a basis weight of 15 g/m² in a pilot plant. The weight of the core being 75% and the weight of the sheath being 25%. The core was made of PLA and the sheath was made of polypropylene. Neither the core nor the sheath contained additives.

### Comparative Example 2

The procedure of Comparative Example 1 was followed but a spunbond of basis weight of 26 g/m² was produced.

COMPARATIVE EXAMPLE 3

The procedure of Comparative Example 1 was followed but in the PLA core 10% by weight, referring to the weight of the core, of a Calcium carbonate (Omyalene 102M) was used.

### COMPARATIVE EXAMPLE 4

The procedure of Comparative Example 3 was followed but a spunbond of basis weight of 26 g/m² was produced.

### EXAMPLE 1

A nonwoven was produced by melt spinning bicomponent fibers with core-sheath configuration and by forming a spunbond with a basis weight of 15 g/m² in a pilot plant. The weight of the core being 75% and the weight of the sheath being 25%. The core was made of PLA and the sheath was made of polypropylene. The core contained 10% by weight, referring to the weight of the core, of a Calcium carbonate (Omyalene 102M). The sheath contained 3% by weight, referring to the weight of the sheath, of a biodegradation promoting adjuvant (Addiflex HE).

### EXAMPLE 2

The procedure of Example 1 was followed but a spunbond of basis weight of 26 g/m² was produced.

In the following table details of the spunbonds prepared in the Comparative Examples 1-4 and in the Examples 1-2 are summarized.

| | | Core- | | Sheath- | Basis |
|---|---|---|---|---|---|
| | Core- | Additive¹⁾ | Sheath | Additive²⁾ | Weight |
| Example | Material | (% b.wt.) | Material | (% b.wt.) | g/m² |
| C1 | PLA | — | PP | — | 15 |
| C2 | PLA | — | PP | — | 26 |
| C3 | PLA | Ca-Carbonate | PP | — | 15 |
| | | (10) | | | |
| C4 | PLA | Ca-Carbonate | PP | — | 26 |
| | | (10) | | | |
| 1 | PLA | Ca-Carbonate | PP | Degradation | 15 |
| | | (10) | | promoter (3) | |
| 2 | PLA | Ca-Carbonate | PP | degradation | 26 |
| | | (10) | | promoter (3) | |

¹⁾Omyalene 102M (Omya)
²⁾Addiflex HE (Add-X)

### Degradation Tests

To check the degradation of the nonwoven samples an oven test was carried out. The oven test was recommended by Add-X (the supplier for the Addiflex additive) and relates well to composting tests.

Nonwoven samples were cut for tensile and elongation tests and the samples were placed in a drier cabinet at 80° C. After several days of treatment the tensile properties were measured. The results are shown in the following tables.

| | | TS/MD¹⁾ | TS/MD¹⁾ | TS/MD¹⁾ | TS/MD¹⁾ | TS/MD¹⁾ |
|---|---|---|---|---|---|---|
| | TS/MD¹⁾ | after 1 day of | after 2 days of | after 4 days of | after 6 days of | after 10 days of |
| | before | thermal | thermal | thermal | thermal | thermal |
| Example | treatment (N) | treatment (N) | treatment (N) | treatment (N) | treatment (N) | treatment (N) |
| C1 | 30 | 29 | 28 | 30 | 28 | 29 |
| C2 | 67 | 67 | 66 | 66 | 64 | 66 |
| C3 | 14 | 13 | 13 | 14 | 13 | 14 |
| C4 | 31 | 32 | 32 | 31 | 30 | 31 |
| 1 | 12 | 12 | 11 | 11 | 2 | 1 |
| 2 | 31 | 31 | 32 | 30 | 10 | 4 |

¹⁾tensile strength in machine direction

| | | peak elongation | peak elongation | peak elongation | peak elongation | peak elongation |
|---|---|---|---|---|---|---|
| | peak elongation | after 1 day of | after 2 days of | after 4 days of | after 6 days of | after 10 days of |
| | before | thermal | thermal | thermal | thermal | thermal |
| Example | treatment (%) | treatment (%) | treatment (%) | treatment (%) | treatment (%) | treatment (%) |
| C1 | 58 | 44 | 42 | 42 | 43 | 40 |
| C2 | 65 | 51 | 51 | 49 | 50 | 49 |
| C3 | 25 | 19 | 19 | 20 | 19 | 18 |
| C4 | 40 | 31 | 30 | 29 | 28 | 28 |
| 1 | 24 | 20 | 18 | 18 | 2 | 1 |
| 2 | 38 | 29 | 30 | 28 | 4 | 2 |

### Discussion of Results

Spunbonds prepared from PLA/PP bicomponent fibers showed a tensile strength which nearly remained unchanged during tempering. The elongation values decreased immediately within one day but remained virtually unchanged afterwards.

Spunbonds prepared from PLA/PP bicomponent fibers and containing Calcium carbonate filler in the core showed the same behavior as the unfilled samples. But addition of the filler strongly decreased the values for tensile strength and elongation of the untreated samples.

Spunbonds prepared from PLA/PP bicomponent fibers and containing Calcium carbonate filler in the core and containing a decomposition promoter adjuvant in the sheath showed the same tensile and elongation properties as the filled samples prior to thermal treatment. After a tempering of 4 days or more the values for tensile strength and for elongation decreased significantly indicating that the spunbonds had been deteriorated. Finally, some of these samples disintegrated when touched.

These results demonstrate that it is possible to manufacture a fully biodegradable PLA/PP bicomponent nonwoven showing tensile properties of known nonwovens.

While the invention has been described in detail, modifications within the spirit and scope of the invention will be readily apparent to those of skill in the art. In view of the foregoing discussion, relevant knowledge in the art and references, including co-pending applications, discussed above in connection with the Background and Detailed Description, the disclosures of which are all incorporated herein by reference, further description is deemed unnecessary.

1-16. (canceled)

17. A bicomponent fiber having a denier between 1 and 10 dtex, comprising:
a first component chosen from the group consisting of aliphatic polyesters and mixtures of aliphatic polyesters; and
a second component comprising an admixture of:
an olefinic polymer chosen from the group consisting of a polyolefin and mixtures of polyolefins ; and
an effective amount of an adjuvant which improves the biodegradability of said olefinic polymer.

18. The bicomponent fiber of claim 17, wherein said bi-component fiber comprises a sheath comprising said first component surrounding a core comprising said second component.

19. The bicomponent fiber of claim 17, wherein the first component is polylactic acid.

20. The bicomponent fiber of claim 17, wherein the second component is chosen from; the group consisting of polyethylene; polypropylene and blends thereof.

21. The bicomponent fiber of claim 17, wherein the adjuvant improving the biodegradability of said polyolefin comprises a starch and a salt of a transition metal compound.

22. The bicomponent fiber of claim 17, wherein the first component further comprises a carbonate of an earth alkaline metal.

23. The bicomponent fiber of claim 22, wherein the first component further comprises calcium carbonate.

24. A textile sheet comprising bicomponent fibers having a denier between 1 and 10 dtex, said fibers comprising:
a first component chosen from the group consisting of aliphatic polyesters and mixtures of aliphatic polyesters; and
a second component comprising an admixture of:
an olefinic polymer chosen from the group consisting of a polyolefin and mixtures of polyolefins; and
an effective amount of an adjuvant which improves the biodegradability of said olefinic polymer.

25. The textile sheet of claim 24, wherein said textile sheet is a nonwoven.

26. The textile sheet of claim 25, wherein the nonwoven is a spunbond.

27. The textile sheet of claim 24, further comprising, in addition to bicomponent fibers, other fibers, said other fibers being selected from the group consisting of polyolefin fibers, viscose fibers, polyester fibers and polyamide fibers.

28. The non-woven textile sheet of claim 25, having an agricultural product chosen from the group consisting of seeds, nutrients for seeds and combinations thereof attached thereto.

29. A medical product comprising a non-woven textile sheet as specified in claim 25, said medical product being chosen from the group consisting of protective clothing, operation coverings, and medical cleaning wipes.

30. A personal care article, comprising bicomponent fibers having a denier between 1 and 10 dtex, said fibers comprising:
a first component chosen from the group consisting of aliphatic polyesters and mixtures of aliphatic polyesters; and
a second component comprising an admixture of:
an olefinic polymer chosen from the group consisting of a polyolefin and mixtures of polyolefins; and
an effective amount of an adjuvant which improves the biodegradability of said olefinic polymer.

31. A personal care article, comprising a textile sheet comprising bicomponent fibers having a denier between 1 and 10 dtex, said fibers comprising:
a first component chosen from the group consisting of aliphatic polyesters and mixtures of aliphatic polyesters; and
a second component comprising an admixture of:
an olefinic polymer chosen from the group consisting of a polyolefin and mixtures of polyolefins; and
an effective amount of an adjuvant which improves the biodegradability of said olefinic polymer.

32. The personal care article of claim 31, wherein the textile sheet is a non-woven.

33. The personal care article of claim 32, wherein the textile sheet is spun-bond fabric.

34. The personal care article of claim 31, wherein the textile sheet, further comprises, in addition to bicomponent fibers, other fibers, said other fibers being selected from the group consisting of polyolefin fibers, viscose fibers, polyester fibers and polyamide fibers.

35. The personal care article as specified in claim 30, wherein the said personal care item is chosen from the group consisting of diapers, wipes, pads, sanitary napkins and tampons.

36. The personal care article as specified in claim 31, wherein the said personal care item is chosen from the group consisting of diapers, wipes, pads, sanitary napkins and tampons.
